(19) United States
(12) Patent Application Publication
(10) Pub. No.: US 2021/0268651 A1
(43) Pub. Date: Sep. 2, 2021

(54) ROBOT CONTROL METHOD

(71) Applicant: SEIKO EPSON CORPORATION, Tokyo (JP)

(72) Inventor: Nobuhiro KARITO, KISO-GUN KISO-MACHI (JP)

(21) Appl. No.: 17/186,019

(22) Filed: Feb. 26, 2021

(30) Foreign Application Priority Data
Feb. 28, 2020 (JP) 2020-033135

(51) Int. Cl. B25J 9/16

(52) U.S. Cl. CPC B25J 9/1661; B25J 9/1664; B25J 9/1697

(57) ABSTRACT

A robot control method for controlling, based on a program including a first instruction including an operation instruction for operating a robot arm and a second instruction, operation of a robot including the robot arm, the robot control method including a first step of controlling the operation of the robot arm based on the first instruction and a second step of controlling the operation of the robot based on the second instruction. In the first step, after execution of the operation instruction is started, it is determined whether a predetermined instruction is included in the second instruction and, when it is determined that the predetermined instruction is included in the second instruction, the predetermined instruction is executed before the first step ends.

The present application is based on, and claims priority from JP Application Serial Number 2020-033135, filed Feb. 28, 2020, the disclosure of which is hereby incorporated by reference herein in its entirety.

### BACKGROUND

### 1. Technical Field

The present disclosure relates to a robot control method.

### 2. Related Art

In recent years, in factories, automation of manually performed work has been accelerated by various robots and peripheral devices of the robots because of a surge in personal expenses and labor shortage. For example, JP-A-2008-254141 (Patent Literature 1) discloses a robot control device that is coupled to a robot including a hand and controls the robot to sequentially execute a plurality of operation instructions described in a program.

The robot control device disclosed in Patent Literature 1 includes robot-program storing means. A robot program is stored in the robot-program storing means. The robot program is a program in which operation instructions to the robot are described in continuous steps by a robot language.

However, when an operation instruction to the robot is complicated processing or an information amount to be processed is large, it is likely that a time until the next operation starts after the preceding operation instruction is completed increases. In this case, a total work time increases.

### SUMMARY

A robot control method according to an aspect of the present disclosure is a robot control method for controlling, based on a program including a first instruction including an operation instruction for operating a robot arm and a second instruction, operation of a robot including the robot arm, the robot control method including: a first step of controlling the operation of the robot arm based on the first instruction; and a second step of controlling the operation of the robot based on the second instruction. In the first step, after execution of the operation instruction is started, it is determined whether a predetermined instruction is included in the second instruction and, when it is determined that the predetermined instruction is included in the second instruction, the predetermined instruction is executed before the first step ends.

### BRIEF DESCRIPTION OF THE DRAWINGS

FIG. 1 is a diagram showing an overall configuration of a robot system in a first embodiment.

FIG. 2 is a block diagram of the robot system shown in FIG. 1.

FIG. 3 is a conceptual diagram showing an example of a program to be executed by the robot system.

FIG. 4 is a time chart of a program to be executed by a robot system of the related art.

FIG. 5 is a time chart showing an example of a program to be executed by the robot system shown in FIG. 1.

FIG. 6 is a time chart showing an example of a program to be executed by the robot system shown in FIG. 1.

FIG. 7 is a flowchart showing an example of a robot control method according to the present disclosure.

FIG. 8 is a flowchart showing details of step S5 in FIG. 7.

FIG. 9 is a flowchart showing details of step S7 in FIG. 7.

FIG. 10 is a flowchart showing details of step S8 in FIG. 7.

### DESCRIPTION OF EXEMPLARY EMBODIMENTS

### First Embodiment

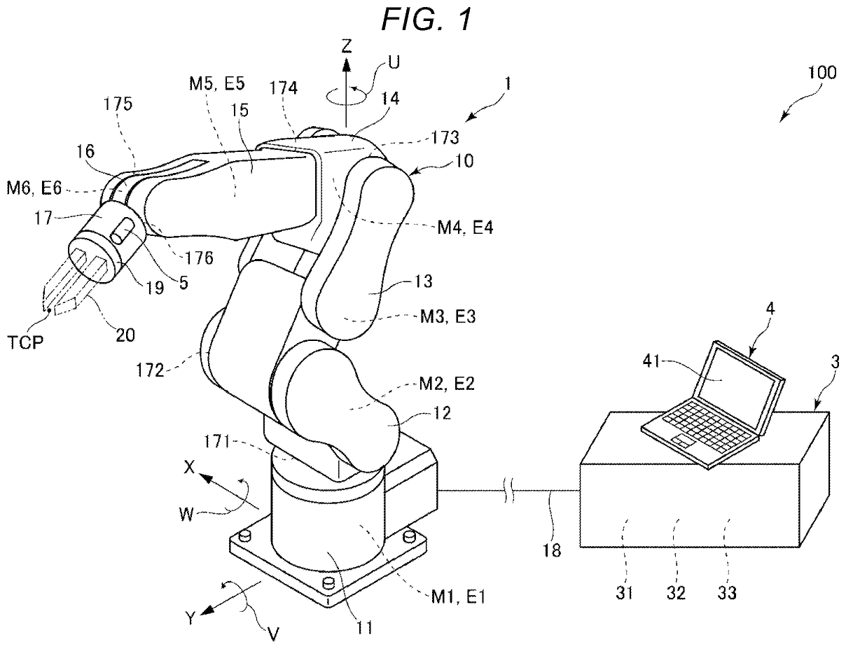

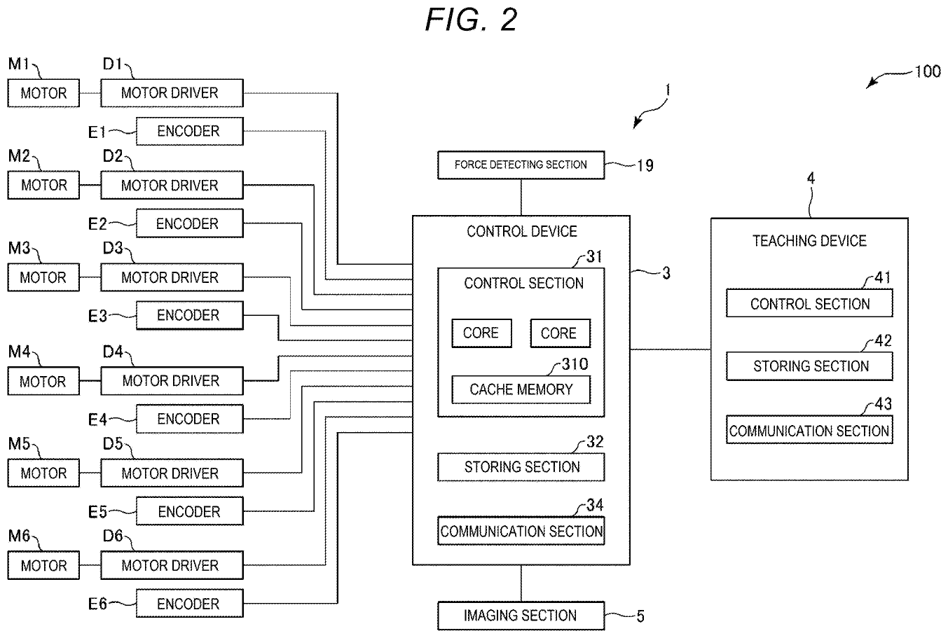

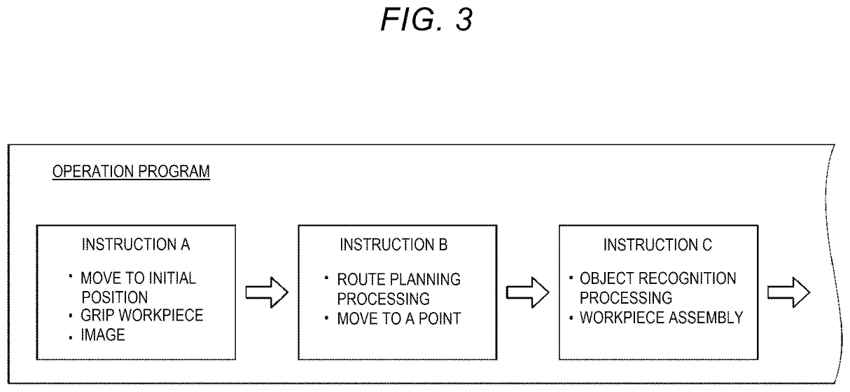

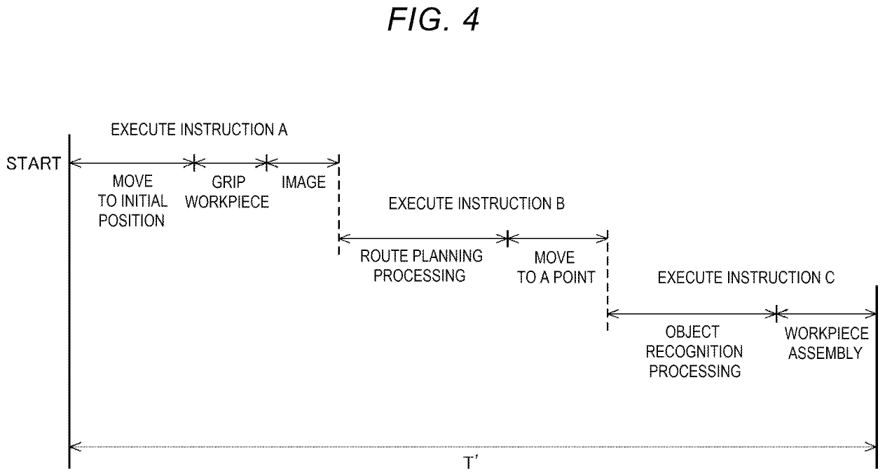

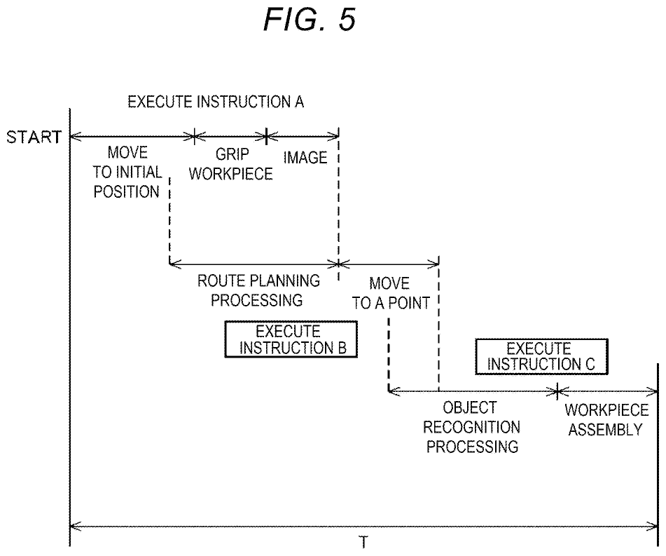

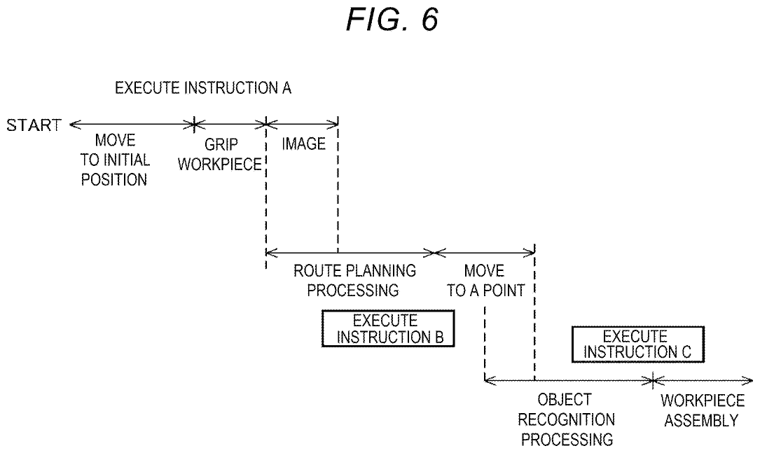

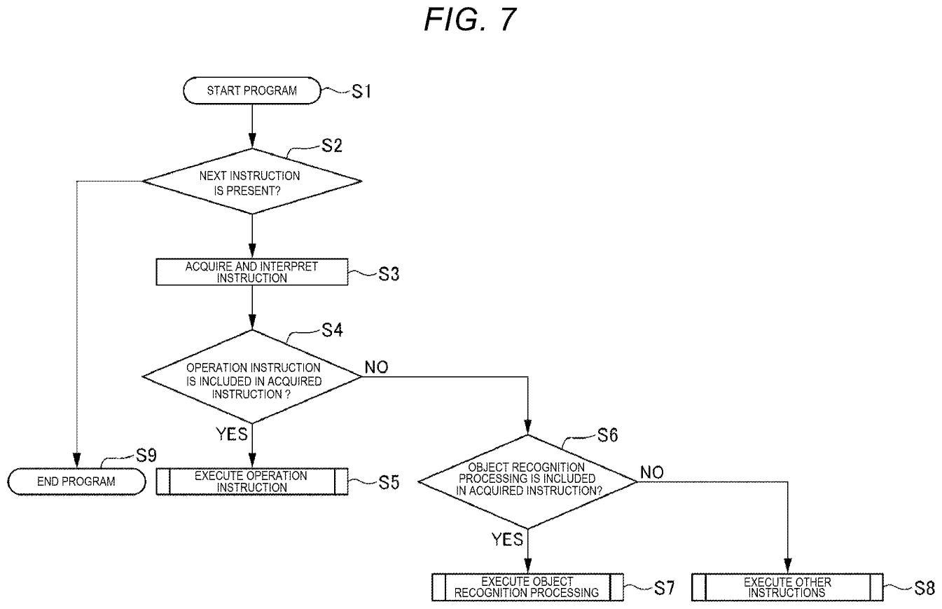

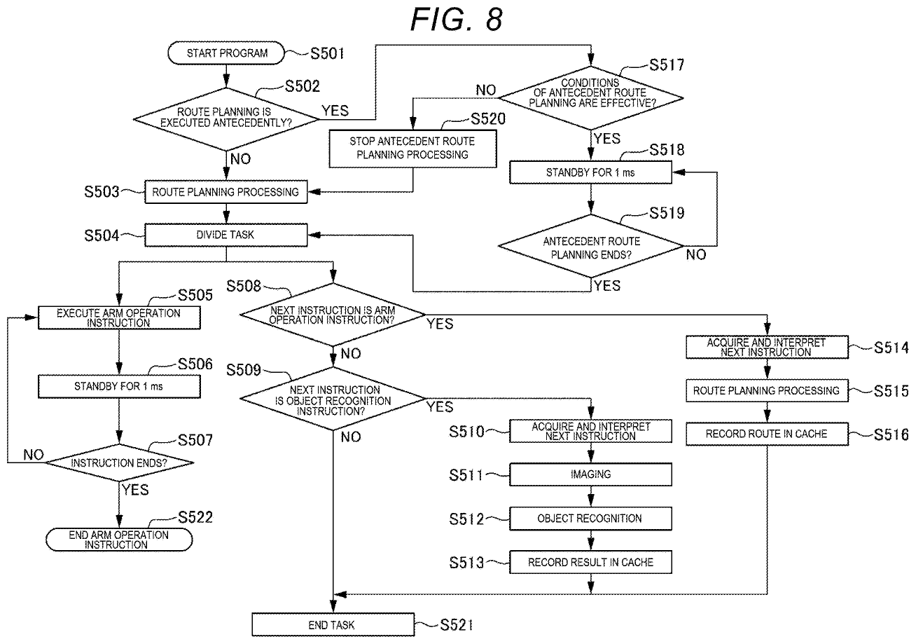

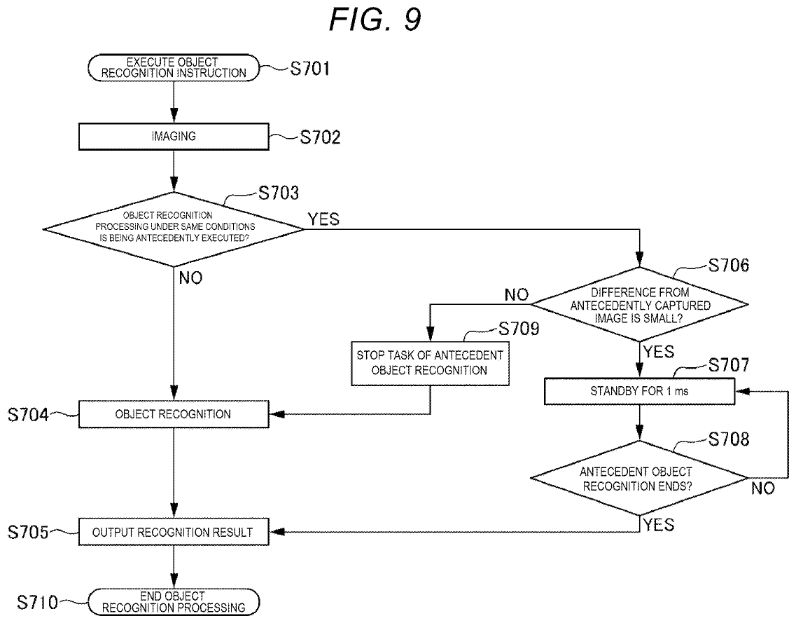

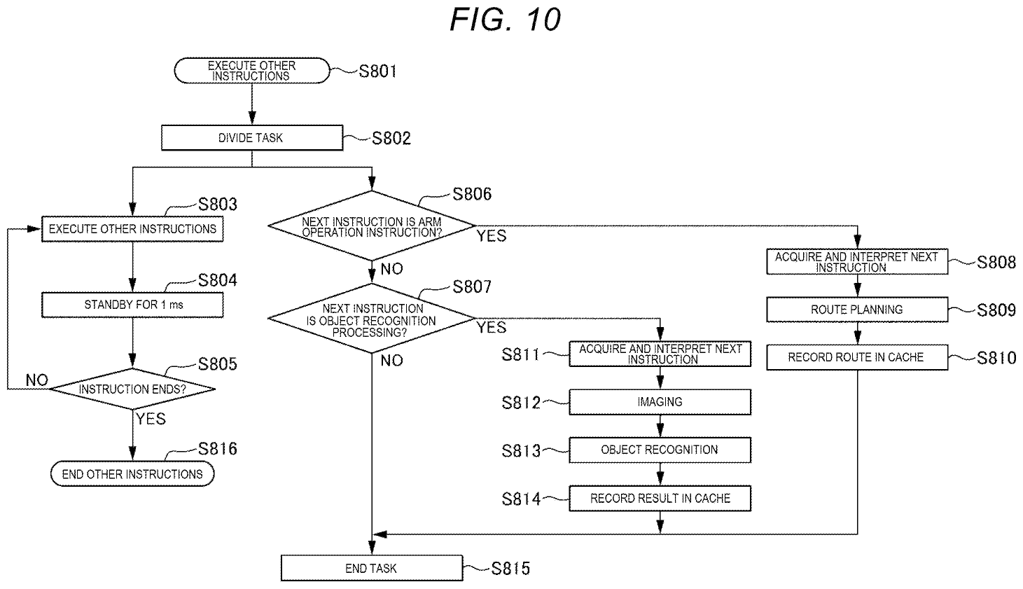

FIG. 1 is a diagram showing an overall configuration of a robot system in a first embodiment. FIG. 2 is a block diagram of the robot system shown in FIG. 1. FIG. 3 is a conceptual diagram showing an example of a program to be executed by the robot system. FIG. 4 is a time chart of a program to be executed by a robot system of the related art. FIG. 5 is a time chart showing an example of a program to be executed by the robot system shown in FIG. 1. FIG. 6 is a time chart showing an example of a program to be executed by the robot system shown in FIG. 1. FIG. 7 is a flowchart showing an example of a robot control method according to the present disclosure. FIG. 8 is a flowchart showing details of step S5 in FIG. 7. FIG. 9 is a flowchart showing details of step S7 in FIG. 7. FIG. 10 is a flowchart showing details of step S8 in FIG. 7.

A robot control method according to the present disclosure is explained in detail below based on a preferred embodiment shown in the accompanying drawings. In the following explanation, for convenience of explanation, a +Z-axis direction, that is, the upper side in FIG. 1 is referred to as “upper” as well and a −Z-axis direction, that is, the lower side in FIG. 1 is referred to as “lower” as well. About a robot arm, a base 11 side in FIG. 1 is referred to as “proximal end” as well and the opposite side of the base 11 side, that is, an end effector 20 side is referred to as “distal end” as well. A Z-axis direction, that is, the up-down direction in FIG. 1 is represented as a “vertical direction” and an X-axis direction and a Y-axis direction, that is, the left-right direction in FIG. 1 is represented as a “horizontal direction”.

As shown in FIG. 1, a robot system 100 includes a robot 1, a control device 3 that controls the robot 1, a teaching device 4, and an imaging section 5 and executes the robot control method according to the present disclosure.

First, the robot 1 is explained.

The robot 1 shown in FIG. 1 is a single-arm six-axis vertical articulated robot in this embodiment and includes a base 11 and a robot arm 10. An end effector 20 can be attached to the distal end portion of the robot arm 10. The end effector 20 may be a constituent element of the robot 1 and may not be the constituent element of the robot 1.

The robot 1 is not limited to the configuration shown in FIG. 1 and may be, for example, a double-arm articulated robot. The robot 1 may be a horizontal articulated robot.

The base 11 is a supporting body that supports the robot arm 10 from the lower side to be able to be driven. The base 11 is fixed to, for example, a floor in a factory. In the robot 1, the base 11 is electrically coupled to the control device 3 via a relay cable 18. The coupling of the robot 1 and the control device 3 is not limited to coupling by wire as in the configuration shown in FIG. 1 and may be, for example, coupling by radio. Further, the robot 1 and the control device 3 may be coupled via a network such as the Internet.

In this embodiment, the robot arm 10 includes a first arm 12, a second arm 13, a third arm 14, a fourth arm 15, a fifth arm 16, and a sixth arm 17. These arms are coupled in this order from the base 11 side. The number of arms included in the robot arm 10 is not limited to six and may be, for example, one, two, three, four, five, or seven or more. The sizes such as the total lengths of the arms are not respectively particularly limited and can be set as appropriate.

The base 11 and the first arm 12 are coupled via a joint 171. The first arm 12 is capable of turning, with respect to the base 11, around a first turning axis parallel to the vertical direction with the first turning axis as a turning center. The first turning axis coincides with the normal of a floor to which the base 11 is fixed.

The first arm 12 and the second arm 13 are coupled via a joint 172. The second arm 13 is capable of turning with respect to the first arm 12 with a second turning axis parallel to the horizontal direction as a turning center. The second turning axis is parallel to an axis orthogonal to the first turning axis.

The second arm 13 and the third arm 14 are coupled via a joint 173. The third arm 14 is capable of turning with respect to the second arm 13 with a third turning axis parallel to the horizontal direction as a turning center. The third turning axis is parallel to the second turning axis.

The third arm 14 and the fourth arm 15 are coupled via a joint 174. The fourth arm 15 is capable of turning with respect to the third arm 14 with a fourth turning axis parallel to the center axis direction of the third arm 14 as a turning center. The fourth turning axis is orthogonal to the third turning axis.

The fourth arm 15 and the fifth arm 16 are coupled via a joint 175. The fifth arm 16 is capable of turning with respect to the fourth arm 15 with a fifth turning axis as a turning center. The fifth turning axis is orthogonal to the fourth turning axis.

The fifth arm 16 and the sixth arm 17 are coupled via a joint 176. The sixth arm 17 is capable of turning with respect to the fifth arm 16 with a sixth turning axis as a turning center. The sixth turning axis is orthogonal to the fifth turning axis.

The sixth arm 17 is a robot distal end portion located on the most distal end side in the robot arm 10. The sixth arm 17 can turn together with the end effector 20 according to the driving of the robot arm 10.

The robot 1 includes a motor M1, a motor M2, a motor M3, a motor M4, a motor M5, and a motor M6 functioning as driving sections and an encoder E1, an encoder E2, an encoder E3, an encoder E4, an encoder E5, and an encoder E6. The motor M1 is incorporated in the joint 171 and relatively rotates the base 11 and the first arm 12. The motor M2 is incorporated in the joint 172 and relatively rotates the first arm 12 and the second arm 13. The motor M3 is incorporated in the joint 173 and relatively rotates the second arm 13 and the third arm 14. The motor M4 is incorporated in the joint 174 and relatively rotates the third arm 14 and the fourth arm 15. The motor M5 is incorporated in the joint 175 and relatively rotates the fourth arm 15 and the fifth arm 16. The motor M6 is incorporated in the joint 176 and relatively rotates the fifth arm 16 and the sixth arm 17.

The encoder E1 is incorporated in the joint 171 and detects the position of the motor M1. The encoder E2 is incorporated in the joint 172 and detects the position of the motor M2. The encoder E3 is incorporated in the joint 173 and detects the position of the motor M3. The encoder E4 is incorporated in the joint 174 and detects the position of the motor M4. The encoder E5 is incorporated in the joint 175 and detects the position of the motor M5. The encoder E6 is incorporated in the joint 176 and detects the position of the motor M6.

The encoders E1 to E6 are electrically coupled to the control device 3. Position information, that is, rotation amounts of the motors M1 to M6 are transmitted to the control device 3 as electric signals. The control device 3 drives the motors M1 to M6 via not-shown motor drivers D1 to D6 based on this information. That is, controlling the robot arm 10 means controlling the motors M1 to M6.

A control point CP is set at the distal end of the robot arm 10. The control point CP means a point serving as a reference in performing control of the robot arm 10. In the robot system 100, the position of the control point CP is grasped in a robot coordinate system. The robot arm 10 is driven such that the control point CP moves to a desired position.

In the robot 1, a force detecting section 19 that detects force is detachably set in the robot arm 10. The robot arm 10 can be driven in a state in which the force detecting section 19 is set. In this embodiment, the force detecting section 19 is a six-axis force sensor. The force detecting section 19 detects the magnitudes of forces on three detection axes orthogonal to one another and the magnitudes of torques around the three detection axes. That is, the force detecting section 19 detects force components in the axial directions of an X axis, a Y axis and a Z axis orthogonal to one another, a force component in a W direction around the X axis, a force component in a V direction around the Y axis, and a force component in a U direction around the Z axis. In this embodiment, the Z-axis direction is the vertical direction. The force components in the axial directions can also be referred to as “translational force components”. The force components around the axes can also be referred to as “torque components”. The force detecting section 19 is not limited to the six-axis force sensor and may be sensors having other configurations.

In this embodiment, the force detecting section 19 is set in the sixth arm 17. A setting part of the force detecting section 19 is not limited to the sixth arm 17, that is, an arm located on the most distal end side and may be, for example, another arm or a part between adjacent arms.

The end effector 20 can be detachably attached to the force detecting section 19. In this embodiment, the end effector 20 is configured by a hand that includes a pair of claw sections capable of approaching and separating from each other and grips and releases a workpiece with the claw sections. The end effector 20 is not limited to the configuration shown in FIG. 1 and may be a hand that grips a work target object by suction. The end effector 20 may be a polisher, a grinder, or a cutter or a tool such as a driver or a wrench.

In the robot coordinate system, a tool center point TCP, which is a control point, is set at the distal end of the end effector 20. In the robot system 100, by grasping the position of the tool center point TCP in the robot coordinate system, the tool center point TCP can be set as a reference of control.

The imaging section 5 is explained.

The imaging section 5 shown in FIGS. 1 and 2 can be configured to include, for example, an imaging element configured by a CCD (Charge Coupled Device) image sensor including a plurality of pixels and an optical system including a lens. As shown in FIG. 2, the imaging section 5 is electrically coupled to the control device 3. The imaging section 5 converts light received by the imaging element into an electric signal and outputs the electric signal to the control device 3. That is, the imaging section 5 transmits an imaging result to the control device 3. The imaging result may be a still image or may be a moving image.

In the configuration shown in FIGS. 1 and 2, the imaging section 5 is provided in the sixth arm 17. However, the imaging section 5 is not limited to such a configuration and may be configured to be set in, for example, a part other than the robot 1, for example, a structure set near a workpiece surface on which a workpiece is disposed.

The control device 3 and the teaching device 4 are explained. In the following explanation in this embodiment, the control device 3 executes the robot control method according to the present disclosure. However, the present disclosure is not limited to this. For example, the teaching device 4 may execute the robot control method or the control device 3 and the teaching device 4 may share the execution of the robot control method.

As shown in FIGS. 1 and 2, in this embodiment, the control device 3 is set in a position away from the robot 1. However, the control device 3 is not limited to this configuration and may be incorporated in the base 11. The control device 3 has a function of controlling driving of the robot 1 and is electrically coupled to the sections of the robot 1. The control device 3 includes a control section 31, a storing section 32, and a communication section 33. These sections are communicably coupled to one another via, for example, a bus.

The control section 31 is configured by a processor such as a CPU (Central Processing Unit) or an MPU (Micro Processing Unit) and reads out and executes various programs and the like stored in the storing section 32. An instruction signal generated by the control section 31 is transmitted to the robot 1 via the communication section 33. Consequently, the robot arm 10 can execute predetermined work.

The control section 31 is capable of executing the robot control method according to the present disclosure irrespective of whether the control section 31 is a single-core processor that operates in a multitasking manner or is a multicore processor as shown in FIG. 2. In particular, by using the multicore processor, it is possible to allocate execution of different programs to cores. Consequently, as explained below, it is possible to temporally redundantly execute different programs.

When the multicore processor is used as the control section 31, it is preferable that a general-purpose OS such as Linux (registered trademark) is allocated to the cores. Consequently, types of processing performed by the cores increases. The control section 31 is excellent in versatility.

The control section 31 includes a cache memory 310.

The storing section 32 saves various programs and the like executable by the control section 31. Examples of the storing section 32 include a volatile memory such as a RAM (Random Access Memory), a nonvolatile memory such as a ROM (Read Only Memory), and a detachable external storage device.

The communication section 33 performs transmission and reception of signals between the communication section 33 and the sections of the robot 1 and between the communication section 33 and the teaching device 4 using an external interface such as a wired LAN (Local Area Network) or a wireless LAN.

The teaching device 4 is explained.

As shown in FIGS. 1 and 2, the teaching device 4 has a function of creating an operation program and inputting the operation program to the robot arm 10. The teaching device 4 includes a control section 41, a storing section 42, and a communication section 43. The teaching device 4 is not particularly limited. Examples of the teaching device 4 include a tablet computer, a personal computer, a smartphone, and a teaching pendant.

The control section 41 is configured by, for example, a CPU (Central Processing Unit) and reads out and executes various programs such as a teaching program stored in the storing section 42. The teaching program may be a teaching program generated by the teaching device 4, may be a teaching program stored from an external recording medium such as a CD-ROM, or may be a teaching program stored via a network or the like.

A signal generated by the control section 41 is transmitted to the control device 3 of the robot 1 via the communication section 43. Consequently, the robot arm 10 can execute predetermined work under predetermined conditions.

The storing section 42 saves various programs and the like executable by the control section 41. Examples of the storing section 42 include a volatile memory such as a RAM (Random Access Memory), a nonvolatile memory such as a ROM (Read Only Memory), and a detachable external storage device.

The communication section 43 performs transmission and reception of signals between the communication section 43 and the control device 3 using an external interface such as a wired LAN (Local Area Network) or a wireless LAN.

The robot system 100 is explained above.

In such a robot system 100, the operation program is input to and stored in the storing section 32 of the control device 3 from the teaching device 4. The control section 31 controls the operation of the robot 1 based on the operation program stored in the storing section 32.

The operation program is a program in which instructions to the robot 1 are described in continuous steps by a robot language. FIG. 3 is a conceptual diagram showing an example of a program executed by the robot system 100. As shown in FIG. 3, the operation program includes instructions, which are unit programs. These instructions and order of executing the instructions are linked. In FIG. 3, an instruction A, which is a first instruction, an instruction B, which is the next instruction of the instruction A, and an instruction C, which is the next instruction of the instruction B, are representatively shown.

The instruction A includes an instruction “move to an initial position”, an instruction “grip a workpiece”, and an instruction “image”. Driving the robot 1 based on the instruction A means sequentially executing “move to an initial position”, “grip a workpiece”, and “image”.

The instruction “move to an initial position” includes information concerning a coordinate of an initial position, a target position of movement to which the control point CP moves. The initial position includes information concerning a coordinate of a target position to which the control point CP moves in the robot coordinate system. This operation instruction also includes a posture of the robot arm 10 in any position halfway in a route.

The instruction “grip a workpiece” is an instruction to bring the pair of claw sections of the end effector 20 close to each other to grip a workpiece. The instruction “image” is an instruction to image a peripheral environment of the robot 1, for example, a not-shown workbench and the peripheral surface of the workbench using the imaging section 5.

The instruction A is completed by sequentially executing the instructions “move to an initial position”, “grip a workpiece”, and “image”. When the instruction A is completed, the instruction B is executed.

The instruction B includes an instruction “route planning processing” and an instruction “move to an A point”. Driving the robot 1 based on the instruction B means sequentially executing the “route planning processing” and the “move to an A point”.

The “route planning processing” is processing for calculating a route that the control point CP passes and a posture of the control point CP at that time. In the route planning processing, for example, based on an imaging result in the instruction A, an A point at a conveying destination of a workpiece, that is, a target position and a posture in passing the route are calculated such that an obstacle and the robot arm 10 do not come into contact. That is, the route means a set of coordinates that the control point CP passes and postures of the robot arm 10 in the coordinates. The route planning processing means processing for calculating the coordinates that the control point CP passes and the postures and storing the coordinates and the postures in the storing section 32.

The “move to an A point” is processing for executing the route generated in the route planning processing. That is, the “move to an A point” means driving the robot arm 10 such that the control point CP passes the coordinates calculated in the “route planning processing” in desired postures.

The instruction B is completed by sequentially executing the “route planning processing” and the “move to an A point”. When the instruction B is completed, the instruction C is executed.

The instruction C includes an instruction “object recognition processing” and an instruction “workpiece assembly”. Driving the robot 1 based on the instruction C means sequentially executing the “object recognition processing” and the “workpiece assembly”.

The “object recognition processing” means specifying an object and recognizing the object in the robot coordinate system using the imaging section 5. Examples of the object recognition processing include recognition of an obstacle and recognition of an assembly target part of an assembly target object. Examples of the assembly target part of the assembly target object include an insertion hole into which a currently gripped workpiece is inserted. The “workpiece assembly” means assembling the currently gripped workpiece to the assembly target object.

The instruction C is completed by sequentially executing such instructions “object recognition processing” and “workpiece assembly”. Types of instructions are not limited to the instructions explained above and include, for example, a standby instruction, an initial position return instruction, and an operation speed change instruction.

Among the kinds of processing explained above, the instruction “move to an initial position” in the instruction A and the instruction “move to an A point” in the instruction B are operation instructions for causing the robot arm 10 to operate. The operation instructions are processing, occupancy ratios of the cache memory 310 and a not-shown system bus by which are relatively low when being executed. In the following explanation, the operation instructions are also referred to as “simple processing” as well. On the other hand, the “route planning processing” in the instruction B and the “object recognition processing” in the instruction C are processing, occupancy ratios of the cache memory 310 and the not-shown system bus by which are relatively high when being executed. In the following explanation, the “route planning processing” and the “object recognition processing” are referred to as “complicated processing” as well.

In the robot system of the related art, it is likely that a phenomenon shown in FIG. 4 occurs when the instructions A to C explained above are executed. FIG. 4 is a time chart showing a state in which the operation program is executed. As shown in FIG. 4, when the instructions A to C are sequentially executed, a total work time is a time T′. The “route planning processing” and the “object recognition processing” are processing that consumes a relatively long time among the instructions. On the other hand, the processing other than the “route planning processing” and the “object recognition processing” can be executed in a relatively short time. In particular, in the “route planning processing” and the “object recognition processing”, although the processing takes time, the operation of the robot arm 10 is stopped. Work efficiency is deteriorated when a stop time of the robot arm 10 is long.

In contrast, in the present disclosure, by adopting a configuration shown in FIG. 5, the total work time can be set to a time T shorter than the time T′ of the related art. This is explained below.

In the robot system 100, after the “move to an initial position”, which is the simple processing included in the instruction A, is started, it is determined whether the “route planning processing” or the “object recognition processing”, which is the complicated processing, is included in the instruction B. When the “route planning processing” is included as shown in FIG. 5, the “route planning processing” is started antecedently. Specifically, the “route planning processing” is performed in parallel during execution of the “move to an initial position”. In other words, the complicated processing of the instruction B is started antecedently during execution of the operation instruction, which is the simple processing of the instruction A. The same applies to the instruction B and the instruction C. After the processing by the operation instruction of the instruction B is started, it is determined whether the complicated processing is included in the instruction C. When the complicated processing is included in the instruction C as shown in FIG. 5, the complicated processing of the instruction C, that is, the “object recognition processing” is started antecedently during execution of the operation instruction of the instruction B.

With such a configuration, a time in which the instruction A is executed and a time in which the instruction B is executed overlap and the time in which the instruction B is executed and a time in which the instruction C is executed overlap. Since these times overlap, the total work time can be set to the time T shorter than the time T′ of the related art. When the instructions A to C are executed, a time in which the robot arm 10 is stopped can be set to a time shorter than the time of the related art. Consequently, productivity can be improved. Since the temporally overlapping kinds of processing are the simple processing and the complicated processing, a load on the control section 31 can be reduced.

In the robot system 100, it is determined whether the complicated processing is included in the instruction B during the execution of the operation instruction of the instruction A. When the complicated processing is included in the instruction B, the complicated processing of the instruction B only has to be started before the instruction A is completed. The same applies to the instruction B and the instruction C. For example, as shown in FIG. 6, the “route planning processing” of the instruction B may be started after the processing of “move to an initial position”, which is the operation instruction, is completed in the instruction A.

The three instructions of the instructions A to C are explained above as an example. However, even if there are four or more instructions, if there is an instruction including the operation instruction, the present disclosure can be applied by assuming that the instruction is a first instruction and assuming that the next instruction is a second instruction.

An example of the robot control method according to the present disclosure is explained based on flowcharts of FIGS. 7 to 10. In the following explanation, the “next instruction” means a unit program such as the instructions A to C explained above. Specifically, for example, the next instruction during the execution of the instruction A means the instruction B.

First, in step S1, the control section 31 starts a program. That is, the control section 31 stores a program input from the teaching device 4 shown in FIG. 1 in the storing section 32 and starts execution of a first unit program among unit programs.

Subsequently, in step S2, the control section 31 determines whether the next instruction is present. When determining that the next instruction is absent, the control section 31 ends the program in step S9. When determining in step S2 that the next instruction is present, in step S3, the control section 31 acquires and interprets the next instruction. That is, the control section 31 reads out the next instruction and interprets a robot language.

Subsequently, in step S4, the control section 31 determines whether the operation instruction is included in the acquired instruction. When determining in step S4 that the operation instruction is included, the control section 31 executes the operation instruction in step S5. Details of step S5 are explained below.

When determining in step S4 that the operation instruction is not included, in step S6, the control section 31 determines whether the object recognition processing is included in the acquired instruction. When determining in step S6 that the object recognition processing is included, in step S7, the control section 31 executes the object recognition processing. The control section 31 returns to step S2. Details of step S7 are explained below.

On the other hand, when determining in step S6 that the object recognition processing is not included in the acquired instruction, in step S8, the control section 31 executes the other instructions. The control section 31 returns to step S2. Details of step S8 are explained below.

In the flowchart of FIG. 7, a loop first round is a first step and a loop second round is a second step.

Details of step S5 are explained based on the flowchart of FIG. 8.

First, in step S501, the control section 31 starts execution of the operation instruction. That is, the control section 31 drives the robot arm 10. Subsequently, in step S502, the control section 31 determines whether the route planning processing is executed antecedently. That is, the control section 31 determines whether the route planning processing is executed in the present situation. VVhen determining in step S502 that the route planning processing is executed antecedently, the control section 31 shifts to step S517. Step S517 and subsequent steps are explained below.

When determining in step S502 that the route planning processing is not executed antecedently, in step S503, the control section 31 executes the route planning processing. When a route is designated in the first operation instruction, this step can be omitted.

Subsequently, in step S504, the control section 31 divides a task. That is, the control section 31 starts two tasks and temporally redundantly processes the tasks. In one task, the control section 31 processes steps S505 to S507 and step S522. In the other task, the control section 31 processes steps S508 to S516 and step S521.

In step S505, the control section 31 starts execution of the operation instruction. That is, the control section 31 acquires information concerning the position and the posture of the robot arm 10 and generates a driving signal for the robot arm 10. Subsequently, in step S506, the control section 31 stays on standby for 1 ms and executes the processing of the other task during the standby. By executing the two tasks in a time division manner, the robot control method according to the present disclosure can be executed by a single-core configuration as well.

In this way, the control section 31 acquires the information concerning the position and the posture of the robot arm 10 at every 1 ms and executes the processing of the other task in a free time. In other words, even if the control section 31 is executing the processing of the other task, the control section 31 interrupts at every 1 ms and performs processing concerning the operation instruction.

In other words, when operating the robot arm 10 according to the operation instruction, the control section 31 acquires the position and the posture of the robot arm 10 and generates the driving signal for the robot arm 10 more preferentially than the route planning processing and the object recognition processing, which are the predetermined instructions. Consequently, it is possible to smoothly execute the operation instruction.

Subsequently, in step S507, the control section 31 determines whether the operation instruction ends. When determining in step S507 that the operation instruction is not completed, the control section 31 returns to step S505 and repeats step S505 and subsequent steps. When determining in step S507 that the operation instruction is completed, in step S522, the control section 31 ends the execution of the operation instruction.

On the other hand, in step S508, the control section 31 determines whether the next instruction is the operation instruction. When determining in step S508 that the next instruction is the operation instruction, in step S514, the control section 31 acquires and interprets the next instruction.

Subsequently, in step S515, the control section 31 executes the route planning processing. As explained above, the route planning processing means processing for calculating coordinates that the control point CP passes and postures of the control point CP and storing the coordinates and the postures in the storing section 32. In step S516, the control section 31 stores a route in the cache memory 310. In step S521, the control section 31 ends the task. By storing the route in the cache memory 310 in step S516, in step S517 explained below in the next loop, the control section 31 can use the route as a determination material.

That is, in the first step, the control section 31 stores an adopted route and uses the adopted route for the next and subsequent route planning processing. Consequently, it is possible to reuse the route if only conditions are satisfied and achieve a reduction in a processing time.

When determining in step S508 that the next instruction is not the operation instruction, in step S509, the control section 31 determines whether the next instruction is the object recognition processing. When determining in step S509 that the next instruction is not the object recognition processing, the control section 31 shifts to step S521 and ends the task.

On the other hand, when determining in step S509 that the next instruction is the object recognition processing, in step S510, the control section 31 acquires and interprets the next instruction. Subsequently, in step S511, the control section 31 performs imaging and acquires a captured image. In step S512, the control section 31 performs object recognition. Such steps S511 and S512 are the object recognition processing. As explained above, examples of the object recognition processing include recognition of an obstacle and recognition of an assembly target part of an assembly target object.

Subsequently, in step S513, the control section 31 stores a result of the object recognition processing in the cache memory 310. In step S521, the control section 31 ends the task.

In the present disclosure, after starting step S505, the control section 31 starts step S508. When determining “Yes” in step S508 or step S509, the control section 31 starts step S510 or step S514 before step S522 is completed. That is, after starting the execution of the operation instruction in the first step, the control section 31 determines whether the “route planning processing” or the “object recognition processing”, which is the predetermined instruction, is included in the next instruction, which is the second instruction. When determining that the predetermined instruction is included in the second instruction, the control section 31 executes the predetermined instruction before the first step ends. With such a configuration, it is possible to cause the time in which the first instruction is executed and the time in which the second instruction is executed to overlap. Therefore, it is possible to set the total work time to the time T shorter than the time T′ of the related art. In executing the instructions A to C, it is possible to set the time in which the robot arm 10 is stopped to a time shorter than the time of the related art. Consequently, it is possible to improve productivity.

In step S502 of step S5 in the loop second or subsequent round, the control section 31 sometimes determines that the route planning processing is being executed antecedently. In this case, in step S517, the control section 31 determines whether conditions of the antecedent route planning processing are effective. This determination is performed according to, for example, whether a route generated in the past is stored in the cache memory 310 or whether a difference between a peripheral environment of the robot 1 and a peripheral environment in the past is within an allowable range when the peripheral environment of the robot 1 and the peripheral environment in the past are compared based on an imaging result. Examples of the peripheral environment of the robot 1 include the position of an obstacle, the position of a workpiece, and the position of an operator.

In this way, the predetermined instruction is the route planning processing for the robot arm 10. In the first step, the control section 31 determines whether a route generated by the route planning processing is adopted. Consequently, it is possible to retry the route planning processing and adopt a route generated in the past according to necessity. Accordingly, it is possible to retry the route planning processing only when the peripheral environment changes. As a result, it is possible to achieve a reduction in processing speed.

When determining in step S517 that the conditions of the antecedent route planning processing are ineffective, in step S520, the control section 31 stops the antecedent route planning processing, shifts to step S503, and retries the route planning processing.

In this way, when determining that the route cannot be adopted, the control section 31 retries the route planning processing. Consequently, it is possible to generate an accurate route according to a situation and a peripheral environment of the robot 1 in the present situation.

When determining in step S517 that the conditions of the antecedent route planning processing are effective, in step S518, the control section 31 stays on standby for 1 ms. In step S519, the control section 31 determines whether the antecedent route planning processing ends. That is, the control section 31 determines at every 1 ms whether the antecedent route planning processing ends. When determining in step S519 that the antecedent route planning processing ends, the control section 31 shifts to step S504.

Details of step S7 are explained based on the flowchart of FIG. 9.

First, in step S701, the control section 31 starts the object recognition processing. Subsequently, in step S702, the control section 31 performs imaging using the imaging section 5. As explained above, examples of an imaging target include an assembly target part of an assembly target object.

Subsequently, in step S703, the control section 31 determines whether the object recognition processing under the same conditions is being executed antecedently. When determining in step S703 that the object recognition processing under the same conditions is not being executed antecedently, in step S704, the control section 31 performs object recognition. That is, the control section 31 specifies a target part in an imaging result as a robot coordinate. In step S705, the control section 31 outputs a recognition result, that is, the robot coordinate of the target part and stores the recognition result in the cache memory 310 or the storing section 32.

When determining in step S703 that the object recognition processing under the same conditions is being executed antecedently, the control section 31 determines whether a difference from an image (an imaging result) captured antecedently is small. That is, in the second and subsequent loops, when an imaging result in the past is stored, that is, when step S513 is executed in the past, the control section 31 compares the imaging result in the past and an imaging result in the present situation (step S702). When the difference is small, that is, within an allowable range in step S706, in step S707, the control section 31 stays on standby for 1 ms. In step S708, the control section 31 determines whether the antecedent object recognition is completed. That is, the control section 31 determines at every 1 ms whether the antecedent object recognition ends. When determining in step S708 that the antecedent object recognition ends, the control section 31 shifts to step S705.

On the other hand, when determining in step S706 that the difference is large, that is, exceeds the allowable range, in step S709, the control section 31 stops a task of the antecedent object recognition and shifts to step S704.

In this way, the predetermined instruction carried out antecedently is the object recognition processing. In the object recognition processing, the control section 31 images the peripheral environment of the robot 1 and specifies the position of the object in the imaging result. Consequently, it is possible to accurately perform the following processing based on the imaging result.

In the object recognition processing, when the imaging result in the past is stored, the control section 31 compares the imaging result in the past and the imaging result in the present situation and, when the difference between the imaging results is within the allowable range, uses the imaging result in the past and, when the difference exceeds the allowable range, uses the imaging result in the present situation. Consequently, since the imaging result only has to be stored in the cache memory 310 or the storing section 32 according to necessity, it is easy to secure a free space of the cache memory 310 or the storing section 32. It is possible to achieve simplification of the object recognition processing.

Details of step S8 are explained based on the flowchart of FIG. 10.

First, in step S801, the control section 31 starts execution of the other instructions. As explained above, examples of the other instructions include the standby instruction, the initial position return instruction, and the operation speed change instruction.

Subsequently, in step S802, the control section 31 divides a task. That is, the control section 31 starts two tasks and temporarily redundantly processes the tasks. In one task, the control section 31 processes steps S803 to S805 and step S816. In the other task, the control section 31 processes steps S806 to S815.

In step S803, the control section 31 executes the other instructions. The other instructions are as explained above. Subsequently, in step S804, the control section 31 stays on standby for 1 ms and executes processing of the other task during the standby. Subsequently, the control section 31 determines whether the other instructions end. In step S816, the control section 31 ends the execution of the other instructions.

On the other hand, in step S806, the control section 31 determines whether the next instruction is an operation instruction for the robot arm. When determining in step S806 that the next instruction is the operation instruction, in step S808, the control section 31 acquires and interprets the next instruction. In step S809, the control section 31 executes the route planning processing. The route planning processing is the same as step S515 explained above. Subsequently, the control section 31 stores the generated route in the cache memory 310, shifts to step S815, and ends the task.

When determining in step S806 that the next instruction is not the operation instruction, in step S807, the control section 31 determines whether the next instruction is the object recognition processing. When determining that the next instruction is not the object recognition processing, in step S815, the control section 31 ends the task.

On the other hand, when determining in step S807 that the next instruction is the object recognition processing, in step S811, the control section 31 acquires and interprets the next instruction. In step S812, the control section 31 performs imaging and acquires a captured image. In step S813, the control section 31 performs object recognition. Such steps S811 and S812 are the object recognition processing. Details of the object recognition processing are as explained above.

Subsequently, in step S814, the control section 31 stores a result of the object recognition processing in the cache memory 310. In step S815, the control section 31 ends the task.

As explained above, the robot control method according to the present disclosure is the robot control method for controlling, based on the program including the first instruction including the operation instruction for operating the robot arm 10 and the second instruction, the operation of the robot 1 including the robot arm 10. The robot control method includes the first step of controlling the operation of the robot arm 10 based on the first instruction and the second step of controlling the operation of the robot 1 based on the second instruction after the first step is completed. After the execution of the operation instruction is started in the first step, it is determined whether the route planning processing or the object recognition processing, which is the predetermined instruction, is included in the second instruction and, when it is determined that the route planning processing or the object recognition processing is included in the second instruction, the route planning processing or the object recognition processing is executed before the first step ends. Consequently, when the predetermined instruction is included in the second instruction, the time in which the first instruction is executed and the time in which the second instruction is executed overlap. Accordingly, since the times overlap, it is possible to set the total work time to the time shorter than the time of the related art. Therefore, it is possible to improve productivity.

When it is determined in the first step that the route planning processing or the object recognition processing, which is the predetermined instruction, is included in the second instruction, the route planning processing or the object recognition processing is executed temporally redundantly with the operation of the robot arm 10. With such a configuration, the execution of the operation instruction, which is the simple processing, and the route planning processing or the object recognition processing, which is the complicated processing, temporarily overlap. Accordingly, it is possible to reduce a load on the control section 31.

The predetermined instruction included in the second instruction is the route planning processing or the object recognition processing for the robot arm 10. The route planning processing and the object recognition processing are complicated and time-consuming processing, occupancy ratios of the cache memory 310 and a not-shown system bus by which are relatively high when being executed. The effects of the present disclosure becomes more conspicuous by executing such a predetermined instruction temporarily redundantly with the first instruction and antecedently.

The robot control method according to the present disclosure is explained about the illustrated embodiment above. However, the present disclosure is not limited to this. The steps of the robot control method can be replaced with any steps that can exert the same functions. Any steps may be added to the robot control method.

In the embodiment, the standby time of the control section 31 is explained as 1 ms. However, in the present disclosure, the standby time is not limited to this.

What is claimed is:

1. A robot control method for controlling, based on a program including a first instruction including an operation instruction for operating a robot arm and a second instruction, operation of a robot including the robot arm,
the robot control method comprising:
a first step of controlling the operation of the robot arm based on the first instruction; and
a second step of controlling the operation of the robot based on the second instruction, wherein
in the first step, after execution of the operation instruction is started, it is determined whether a predetermined instruction is included in the second instruction and, when it is determined that the predetermined instruction is included in the second instruction, the predetermined instruction is executed before the first step ends.

2. The robot control method according to claim 1, wherein, in the first step, when it is determined that the predetermined instruction is included in the second instruction, the predetermined instruction is executed temporally redundantly with the operation of the robot arm.

3. The robot control method according to claim 1, wherein, when the robot arm is operated by the operation instruction, a position and a posture of the robot arm are acquired more preferentially than the predetermined instruction.

4. The robot control method according to claim 1, wherein the predetermined instruction is route planning processing or object recognition processing for the robot arm.

5. The robot control method according to claim 1, wherein
the predetermined instruction is route planning processing for the robot arm, and
the route planning processing determines whether a route generated by the route planning processing is adopted.

6. The robot control method according to claim 5, wherein, when it is determined that the route is not adopted, the route planning processing is retried.

7. The robot control method according to claim 5, wherein, in the first step, the adopted route is stored and used for the route planning processing of next and subsequent times.

8. The robot control method according to claim 1, wherein
the predetermined instruction is the object recognition processing, and
in the object recognition processing, a peripheral environment of the robot is imaged and a position of an object in an imaging result is specified.

9. The robot control method according to claim 8, wherein, in the object recognition processing, when an imaging result in past is stored, the imaging result in the past and an imaging result in a present situation are compared and, when a difference between the imaging results is within an allowable range, the imaging result in the past is used and, when the difference exceeds the allowable range, the imaging result in the present situation is used.
